(19) United States
(12) Patent Application Publication
(10) Pub. No.: US 2005/0037246 A1
(43) Pub. Date: Feb. 17, 2005

(54) Fuel cell system with a mass flow sensor

(76) Inventors: Dirk Hunkel, Aachen (DE); Wolfgang Maurer, Esslingen (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/491,713

(22) PCT Filed: Oct. 1, 2002
(86) PCT No.: PCT/EP02/11003

(30) Foreign Application Priority Data
Oct. 2, 2001 (DE) 101 48 664.2

(51) Int. Cl. H01M 8/04

(52) U.S. Cl. 429/22; 429/24

(57) ABSTRACT

The invention relates to a fuel cell system comprising a gas generating system in which a hydrogen-rich gas is generated and a fuel cell unit having an anode and a cathode, the anode having an inlet line for the hydrogen-rich gas and an exhaust line, and the cathode having an inlet line for an oxygen-rich gas and an exhaust line; a mass flow sensor for the hydrogen-rich gas is arranged in the inlet line of the anode and a thermal mass flow sensor is used as the mass flow sensor.

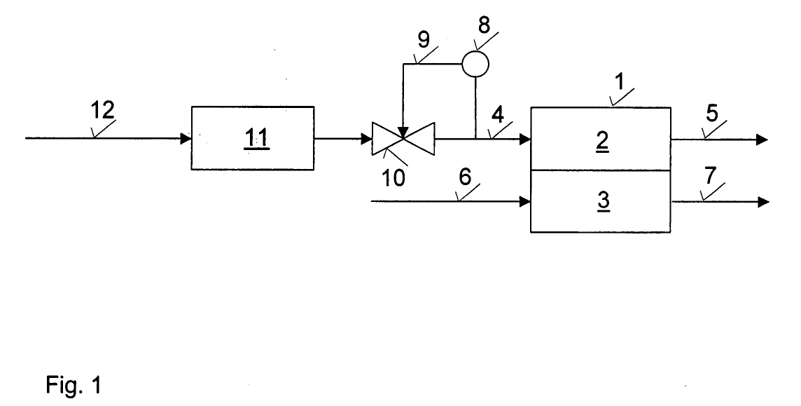

The invention relates to a fuel cell system according to the preamble of claim 1.

Mass flow sensors for air and gases, e.g. hydrogen, are in widespread use in the process industry, e.g. chemicals, petrochemicals, foodstuffs manufacture, waste water treatment and the power generation sector. These applications relate to stationary installations. For use in mobile devices which are generally manufactured in series, such as vehicles, the sensors must fulfil certain additional requirements regarding size, weight, response time and cost. The mass flow sensors used in the process industry generally do not meet these requirements.

For use in vehicles propelled by internal combustion engines, DE 199 53 718 A1 discloses an air mass sensor arranged in the air inlet tract of an internal combustion engine. A further air mass sensor is incorporated directly in the exhaust gas recirculation line as an exhaust gas mass sensor. The air mass sensor disclosed in DE 199 53 718 A1 fulfils the additional requirements resulting from use in a mobile device.

In JP 61051773 A, flow rate sensors are used in a fuel cell system in order to determine the utilisation factors of hydrogen and oxygen. The flow rate sensors are arranged in the inlet and exhaust lines of the anode and cathode of a fuel cell unit.

In contrast, it is the object of the invention to provide a fuel cell system in which the quantity of hydrogen-rich gas can be determined in a rapid and cost-effective manner.

This object is achieved by a fuel cell system with the features of claim 1.

The advantage of the invention is that a mass flow sensor is created which combines the advantages of the air mass sensor with a range of applications of a mass flow sensor used in the process industry. A mass flow sensor for a hydrogen-rich gas is thereby provided which fulfils the requirements regarding weight, size, cost and response time which apply to use in a mobile device, e.g. a fuel-cell-propelled vehicle.

It is self-evident that the above-mentioned features and those to be elucidated below can be used not only in the particular combination specified but in other combinations or in isolation without departing from the scope of the present invention.

Further advantages and configurations of the invention are apparent from the further claims and from the description.

The invention is described in more detail below with reference to a single drawing, which shows:

a schematic representation of a fuel cell system according to the invention having a thermal mass flow sensor.

The single FIGURE shows a fuel cell system with a fuel cell unit 1. The fuel cell unit 1, which provides, for example, the power for propelling a vehicle, consists of an anode 2 and a cathode 3. A hydrogen-rich gas, e.g. hydrogen, is supplied to the anode 2 via an inlet line 4. Anode exhaust gas is discharged via an exhaust line 5. An oxygen-rich gas is supplied to the cathode 3 via an inlet line 6. Cathode exhaust gas is discharged via an exhaust line 7. A mass flow sensor 8 for measuring the mass flow of the hydrogen-rich gas is arranged in the inlet line 4 of the anode 2. The mass flow sensor 8 is in the form of a thermal mass flow sensor in the manner of an air mass sensor as described, for example, in DE 199 53 718.

The thermal air mass sensor disclosed in DE 199 53 718 A1 operates on the principle of a hot-element anemometer having respective bridge circuits for measuring the forward and return flow of the air mass flow.

The hydrogen-rich gas is preferably generated in a gas generating system 11 from a fuel which is normally a medium containing carbon and hydrogen, e.g. methanol. The fuel is supplied to the gas generating system via a supply line 12.

The thermal mass flow sensor 8 operates preferably on the principle of a hot-element anemometer. In a hot-element anemometer a temperature sensor which detects the temperature of the gas, and a heat sensor which is heated to a particular temperature above the ambient temperature, are known to be located in different branches of a bridge circuit. The heat sensor is cooled by the mass flow of the gas. The additional amount of energy required to maintain the set excess temperature, or a value dependent thereon, is a measure of the mass of gas which passes through. In comparison to other flow rate measurement methods, e.g. Coriolis mass flow measurement, ultrasonic flow rate measurement, induction flow rate measurement, eddy-frequency flow rate measurement, or flow rate measurement using throttling devices, thermal mass flow measurement is characterised by rapid response times of the sensor. The measuring range and the signal/noise ratio depend on the thermal conductivity of the gas and can be influenced by varying the excess temperature. For measuring the mass flow of the hydrogen-rich gas, the signals measured are distinguished by a high signal/noise ratio.

The thermal mass flow sensor 8 preferably includes two heat sensors and two temperature sensors. As is known from the prior art, each sensor is connected to a respective bridge. Through the use of two separate bridge circuits the flow direction of the gas can be determined by comparing the bridge signals or by comparing the amounts of additional energy required to maintain the excess temperatures of the respective heat sensors. Errors in determining mass flow which can occur if a return flow is disregarded can thereby be avoided. The mass flow sensor 8 according to the invention for the hydrogen-rich gas therefore operates on the same principle as a thermal air mass sensor.

The mass flow sensor 8 is connected to a current or voltage source (not shown) for supplying current or voltage. In addition, the mass flow sensor 8 is preferably connected to an evaluation unit (not shown) based, for example, on the use of a microprocessor. The evaluation unit is used for signal preparation or processing, and/or for representing or displaying the signal measured by the mass sensor 8. A sensor fault diagnosis function may also be integrated in the evaluation unit.

The mass flow sensor 8 may advantageously be incorporated in a control path and/or feedback control loop 9 for adjusting the mass flow. The control path or feedback control loop 9 includes a control valve 10 which is arranged upstream of the mass flow sensor 8 and the fuel cell unit 1 and is used for adjusting the mass flow of the hydrogen-rich gas which is supplied to the anode 2 of the fuel cell unit 1 via the inlet line 4. The control valve 10 is controlled, via the evaluation unit (not shown) and/or a feedback/control unit (not shown) which are also integrated advantageously in the feedback control loop 9, in such a way that a larger or smaller quantity of hydrogen-rich gas is supplied to the anode 2. Through the use of the thermal mass flow sensor, which is distinguished by fast response times and supplies measurements for the mass flow of the hydrogen-rich gas to the control or feedback system, the dynamics of the feedback system, for example, in case of abrupt load changes, and therefore the dynamics of the fuel cell system, can be improved.

The sensor 8 according to the invention is used for the mass flow measurement of hydrogen-rich gas and is advantageously contained in a housing (not shown) the material of which has a surface resistance which is preferably less than 10⁹ ohms. In this way the danger of static charging can be reduced or avoided. The seals of the housing are selected according to the medium surrounding the sensor 8, i.e. the hydrogen-rich gas. The components of the sensor 8 according to the invention which carry the medium are preferably executed according to the type of protection of intrinsic safety standard (EN50020).

1. Fuel cell system including a fuel cell unit (1) comprising an anode (2) and a cathode (3), the anode (2) having an inlet line (4) for a hydrogen-rich gas and an exhaust line (5), and the cathode (3) having an inlet line (6) for an oxygen-rich gas and an exhaust line (7), and a mass flow sensor (8) for the hydrogen-rich gas being arranged in the inlet line (4) of the anode (2), characterised in that a thermal mass flow sensor is used as the mass flow sensor (8).

2. Fuel cell system according to claim 1, characterised in that the mass flow sensor (8) is connected to a current or voltage supply.

3. Fuel cell system according to claim 2, characterised in that the mass flow sensor (8) is connected to an evaluation unit.

4. Fuel cell system according to claim 2, characterised in that the mass flow sensor (8) is incorporated in a control path and/or feedback control loop (9).

5. Fuel cell system according to claim 1, characterised in that the mass flow sensor (8) includes two heat sensors and two temperature sensors which are connected to two bridge circuits.

6. Fuel cell system according to claim 1, characterised in that the mass flow sensor (8) is a sensor operating on the principle of a thermal air mass sensor.
